(19) United States
(12) Patent Application Publication
(10) Pub. No.: US 2007/0083465 A1
(43) Pub. Date: Apr. 12, 2007

(54) Method and system using bill payment reminders

(75) Inventors: Peter Ciurea, Martinez, CA (US); Christopher P. Aguas, Novato, CA (US); Peter A. Mendiara, Oakland, CA (US)

Correspondence Address: TOWNSEND AND TOWNSEND CREW LLP, TWO EMBARCADERO CENTER, 8TH FLOOR, SAN FRANCISCO, CA, 94111, US

(73) Assignee: Visa U.S.A., Inc., San Francisco, CA (US)

(21) Appl. No.: 11/329,929

(22) Filed: Jan. 10, 2006

Related U.S. Application Data
(60) Provisional application No. 60/724,497, filed on Oct. 7, 2005.

(51) Int. Cl. G06Q 40/00

(52) U.S. Cl. 705/40

(57) ABSTRACT

A method for automatic bill payment is disclosed. The method includes providing for an automatic bill payment process for a user of a portable consumer device, where the automatic bill payment process automatically pays periodic bills of the user at predetermined times. The method also includes providing for an automatic reminder process, where the automatic reminder process automatically sends reminders to the user of the portable consumer device prior to the automatic payment of the bills at the predetermined time intervals.

### CROSS-REFERENCE TO RELATED APPLICATIONS

This application is a non-provisional of and claims the benefit of the filing date of U.S. Provisional Application No. 60/724,497, filed on Oct. 7, 2005, which is herein incorporated by reference in its entirety for all purposes.

### BACKGROUND OF THE INVENTION

Both manual and automatic bill payments can be made with credit or debit cards. The difference is that manual bill payments are typically individually initiated each time by the cardholder. Automatic bill payments are initiated by the merchant on a recurring basis according to parameters established with the cardholder in advance. Both consumers and small businesses effect bill payments today with both methods. Some small businesses (and for that matter consumers) are reluctant to establish automatic bill payments because of a fear of loss of control of the process, and the potential issues of service interruption for automatic bill payment failures. If automatic payments are attempted and are not processed for some reason (e.g., there are insufficient funds in their accounts), the small business owners' supply chains or services could be disrupted thereby disrupting their businesses. Therefore, many small business owners continue to use manual bill payment methods. By manually paying bills, they are reminded that they need to make sure that there are sufficient funds in their accounts before they pay their bills.

It would be desirable to provide for a method and system that uses an automatic bill payment process that will be more likely to be used by persons such as small business owners. Embodiments of the invention address this and other problems.

### SUMMARY OF THE INVENTION

Embodiments of the invention are directed to methods, computer readable media, servers, and systems that use automatic reminders in conjunction with automatic bill payment processes.

One embodiment of the invention is directed to a method comprising: providing for an automatic bill payment process for a user of a portable consumer device, wherein the automatic bill payment process automatically pays periodic bills of the user at predetermined times; and providing for an automatic reminder process, wherein the automatic reminder process automatically sends reminders to the user of the portable consumer device prior to the automatic payment of the bills at the predetermined times.

Another embodiment of the invention is directed to a method comprising: initiating an automatic bill payment process, wherein the automatic bill payment process automatically pays periodic bills of a user of a portable consumer device at predetermined times; and initiating an automatic reminder process, wherein the automatic reminder process automatically sends reminders to the user prior to the automatic payment of the bills at the predetermined times.

Other embodiments of the invention are directed to systems, computer readable media, and servers that are associated with such methods.

These and other embodiments of the invention are described in further detail below.

### BRIEF DESCRIPTION OF THE DRAWINGS

FIG. 1 shows a flowchart showing a method according to an embodiment of the invention.

FIG. 2 shows a system according to an embodiment of the invention.

FIGS. 3-9 show screenshots of Web pages according to embodiments of the invention.

### DETAILED DESCRIPTION

A method for automatic bill payment is disclosed. The method includes providing for an automatic bill payment process for a user of a portable consumer device, where the automatic bill payment process automatically pays periodic bills of the user at predetermined times. The method also includes providing for an automatic reminder process, where the automatic reminder process automatically sends reminders to the user of the portable consumer device prior to the automatic payment of the bills at the predetermined times (e.g., predetermined time intervals). These steps can be performed by one or more entities including a corporation, an organization (e.g., a non-profit organization), and/or a server computer operated by a corporation or an organization. The bill payment process may be run by a bill payment system while the reminder process may be run by a reminder system. Each process and system may be run by different entities or the same entity.

In embodiments of the invention, a user (e.g., a business owner or an employee of a business) can initiate an automatic bill payment process. The user can then initiate a reminder process and a bill payment notification process.

As used herein the “initiation”of the reminder process, the automatic bill payment process, and/or the bill payment notification process includes situations where the user solely initiates these processes or initiates these processes after being prompted by another entity such as a merchant. For example, a merchant may ask a customer through the Internet or through the U.S. mail if the customer would like to pay the customer's bills automatically using a credit card number or the like. The user may then initiate the process by providing an affirmative response to the merchant, either through the U.S. mail or through the Internet.

In embodiments of the invention, the reminder function can be entirely free form and up to the user of the portable consumer device (e.g., there is no interaction with a merchant). For example, the user can inform the system to send a reminder to the user (e.g., by email or posted to the Web site) at a specified time and/or date, or according to a recurring schedule. The user can also name the reminder and provide specific text for the reminder. So, for example, a user of a portable consumer device could set up a reminder so that it is generated by a server on the 15^{th} of every month to say “monthly insurance premium is due on the 20^{th}.” This reminder message can be sent to the user's e-mail in box or may be posted to the user's Web page. Once the user gets reminders that merchant bills are due for payment, the user can make sure that there are sufficient funds to pay the merchants. This way, the user can be sure that the user's supply chains will not be disrupted.

In addition to the reminder function, a separate or integrated bill payment notification service can allow a user to select from a list of merchants that the user has interacted with (e.g., in the last 120 days). The system can then notify the user whenever there is a future transaction from that same merchant. The notification may come from a server or system operated by a payment processing organization, or from the merchant who issues the users' bills.

The reminder process is particularly beneficial to business consumers that use portable consumer devices such as debit and/or credit cards. Compared to ordinary consumers, business consumers have many payments that need to be made and managed. Some payments may be more important than others and some payments may be delayed where others cannot be delayed. By providing a reminder system, users are provided with a way to manage automatic payment processes for their bills.

Providing for an electronic reminder process with an automatic bill payment process is not necessarily intuitive or obvious. One would expect that automatic bill payment processes would not need reminders, since payors are presumed to know when those payments are to occur. However, by using an automatic reminder system, automatic payment processes are more likely to be used by users of portable consumer devices.

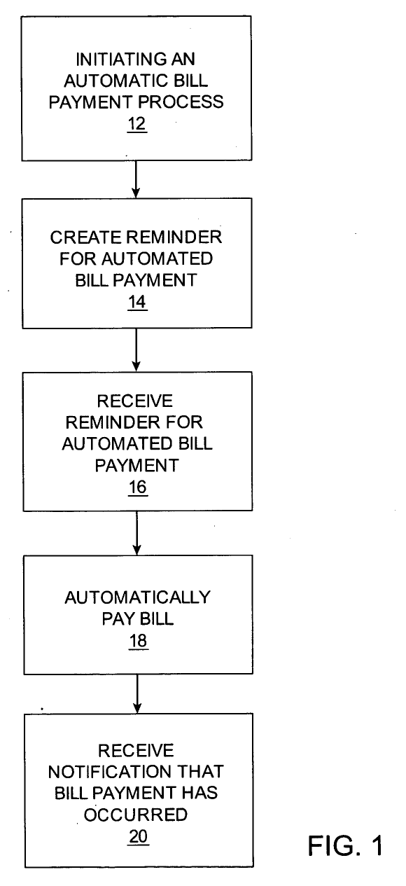

FIG. 1 has a flowchart illustrating a method according to an embodiment of the invention. In the method, the user of one or more portable consumer devices initiates an automatic bill payment process (step 12). The automatic bill payment process can automatically pay bills on behalf of the user of the portable electronic device. The bills can be paid at periodic times including weekly, monthly, bi-weekly, bimonthly, annually, etc.

In some embodiments, the automatic bill payment process can be established by a cardholder and a merchant, completely outside of a reminder system that runs the automatic bill pay reminder service. The actual payment of a bill can occur outside of the reminder system according to parameters established directly between a user (e.g., a customer) and a merchant. The reminder system can enable the user to select from previously billed merchant transaction records in order to receive future notifications whenever payments are made to those selected merchants.

At the same time or after the automatic bill payment process is initiated, a reminder for automatic bill payment is created (step 14). The reminder may be created by the user of the portable consumer device and may remind the consumer before an automatic payment will be made. The reminder may be a one time automatic reminder for a particular automatic payment. The reminder may alternatively be one reminder in a set of automatically recurring reminders that respectively occur between period automatic payments.

The reminder may be created or sent at any suitable time interval before the date that automatic payment is made. For example, a reminder may be created or sent 1 day or 1 week prior to the automatic payment date. If the user is reminded that automatic payment will be made, the user can check to see if there are sufficient funds or if there is sufficient credit in the user's account before bill payment is made. If there are not sufficient funds or credit, then the user may stop the automatic payment process. The user may alternatively fund the appropriate account(s) or take steps to establish sufficient credit for such account(s). If there are sufficient funds and/or credit in the user's account, then the user may simply let the automatic payment process proceed.

After the reminder process has been initiated by the user, the reminders may be received by the user before automatic payment is made (step 16). In some cases, the reminders may be in the form of e-mails that are sent to the user. In another example, the reminders may be posted on a Web page that is accessible to the user. The accessible Web page may be a secured Web page that may be password protected.

The reminders may also be customized by the user or may be pre-prepared by another entity, and may also include any suitable information. For example, the user may customize the reminder to indicate the merchant who provides the bill, the amount of the bill and/or the date of automatic payment. In another example, the reminder may be pre-prepared by another entity such as an issuing bank or a payment processing organization such as Visa or Mastercard. For example, an organization may prepare a list of pre-prepared reminder messages, and the user may select one or more of those messages to use as the user's reminders.

After the reminder is sent and the reminder is received and/or viewed by the user of the portable consumer device, automatic payment is made if the user of the portable consumer device does not stop the automatic payment process (step 18). Automatic payment can be made using an account associated with a portable consumer device. The account may be a debit or credit card account.

The portable consumer devices according to embodiments of the invention may be in any suitable form. For example, the portable consumer devices can be hand-held and compact so that they can fit into a consumer's wallet and/or pocket (e.g., pocket-sized). For example, the portable consumer devices may include smart cards, ordinary credit or debit cards (with a magnetic strip and without a microprocessor), a keychain device (such as the Speedpass™ M commercially available from Exxon-Mobil Corp.), etc. Other examples of portable consumer devices include cellular phones, personal digital assistants (PDAs), pagers, payment cards, security cards, access cards, smart media, transponders, and the like. The portable consumer devices can also be debit devices (e.g., a debit card), credit devices (e.g., a credit card), or stored value devices (e.g., a stored value card). Thus, in embodiments of the invention, the account may be a debit or credit card account.

After the automatic bill payment is made, the user can receive a notification that an automatic payment for a bill has been made (step 20). The notification, like the reminder, may be posted to a Web page that is accessible to the user. Alternatively, the user may elect to receive e-mails that notify them that automatic payments have been made on their behalf. The bill pay notification process may or may not be operationally linked to the previously described reminder process.

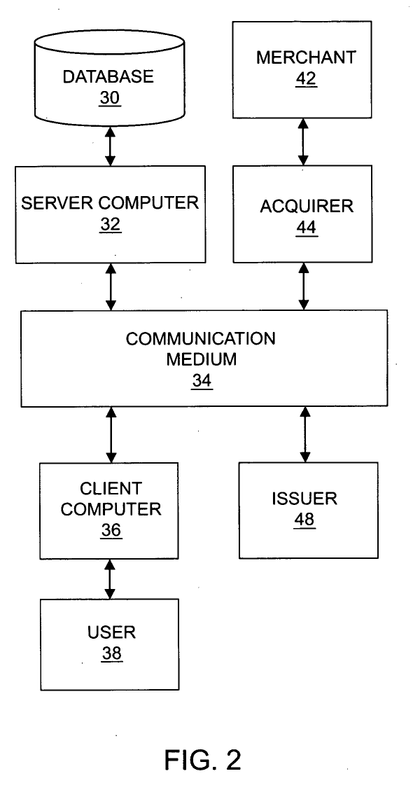

FIG. 2 shows a system according to an embodiment of the invention. The system includes one or more client computers 36 in operative communication with a server computer 32, via a communication medium 34. The server computer 32 may have access to a database 30. The server computer 32 may also directly or indirectly communicate with an issuer 48, an acquirer 44, and a merchant 42.

An “acquirer” is typically a business entity, e.g., a commercial bank, that has a business relationship with a particular merchant. An “issuer” is typically a business entity (e.g., a bank) which issues a portable consumer device such as a credit or debit card to a consumer. Some entities such as American Express perform both issuer and acquirer functions. Embodiments of the invention encompass such single entity issuer-acquirers.

The server computer 32 is typically a powerful computer or cluster of computers. For example, the server computer can be a large mainframe, a minicomputer cluster, or a group of servers functioning as a unit. In one example, the server computer may be a database server coupled to a web server.

The communication medium 34 may comprise or use a payment processing network such as VisaNet. The communication medium 34 may use any suitable wired or wireless network, including the Internet. Although the communication medium 34 is shown as being separate from the server computer 32 in FIG. 2, the communication medium 34 may alternatively include the server computer 32 in other embodiments.

The one or more client computers 36 may include any suitable commercially available computation apparatuses with suitable commercially available Web browsers.

The user 38 of the portable consumer device (not shown) can be any suitable individual or entity. For example, the user 38 can be a person working for a business such as a purchasing agent, or other employee or officer of the business. The merchant 42 may be any suitable entity that sells goods or services.

In a typical method using the system shown in FIG. 2, the user 32 of a portable consumer device can use a client computer 36 to contact a Web site operated by the server computer 32, via the communication medium 34. At the Web site, the user 32 can initiate an automatic bill payment process. The user may then identify the particular merchant or merchants that will be paid automatically using the account number of the user's portable consumer device. For example, the user 32 may use the Web site to indicate that the user would like to automatically pay his utility bill on the 1^{st} of every month using his credit card number. The user then enters his credit card number onto a Web page of the Web site.

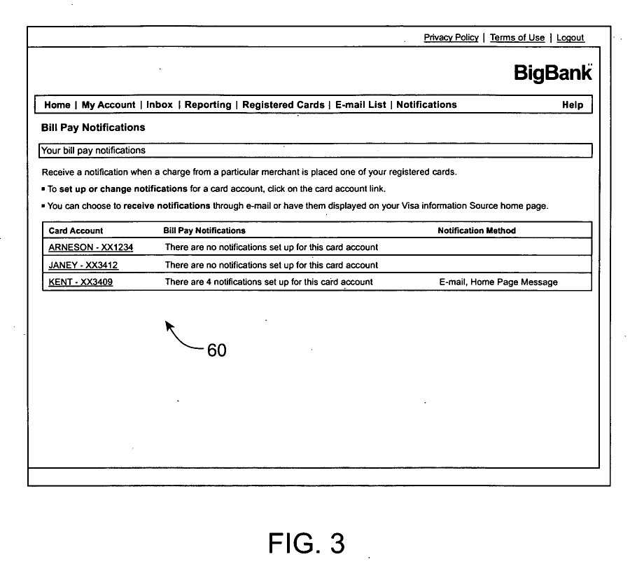

The user 38 may also use the Web site to indicate that the user 38 would like to receive notifications after the automatic payments have been made. For example, FIG. 3 shows an exemplary Web page from an exemplary Web site. The Web page in FIG. 3 allows a person to select from a list of links 60 to the accounts of various users. The number of bill payment notifications associated with the accounts and the notification methods used may also be shown on the Web site.

In this specific example, the automatic bill payment process, the bill pay reminder process, and/or the bill pay notification process may be linked through the same or similar Web site and/or may be operationally linked. However, in other embodiments, the automatic bill payment process, the reminder process, and the bill pay notification process are not linked through the same Web site and/or are not operationally linked. For example, in other embodiments, the automatic bill payment process can first be established by a user and a merchant without regard to the reminder process. The automatic bill payment process can be established between a customer and a merchant using the Internet, or communication modes such as U.S. mail.

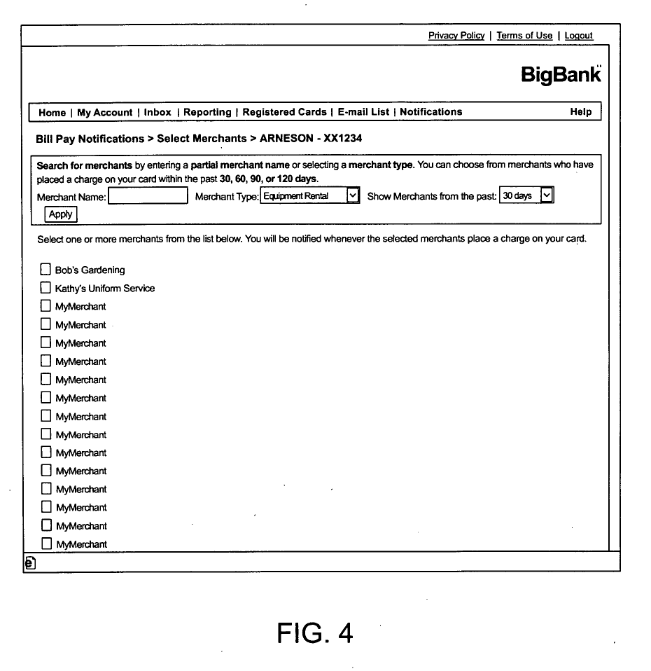

Then, a bill pay notifications setup Web page may be displayed to the user. As shown in FIG. 4, the user may then select one or more merchants from a list of merchants. As shown in FIG. 4, the user may filter for a specific subset of merchants by typing in a merchant name, selecting a merchant type, and/or showing merchants from a predetermined time period (e.g., 30 days).

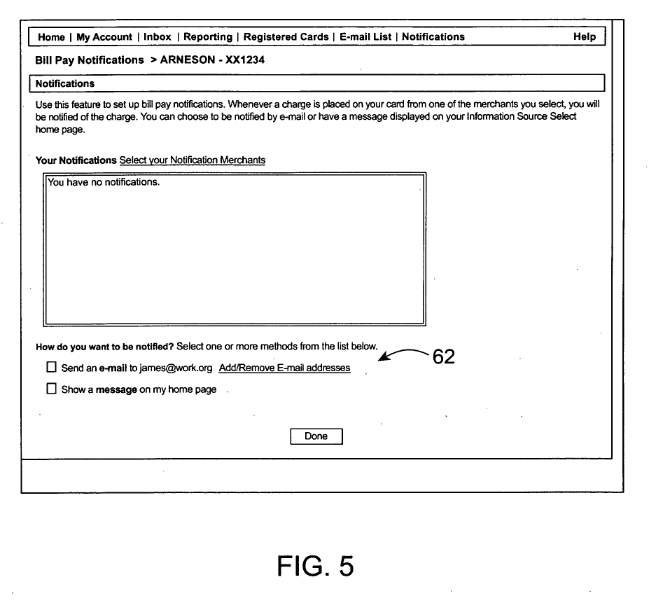

After one or more merchants are selected, the user may then be directed to a notifications setup page. For example, as shown in FIG. 5, the user 38 may then indicate how the user 38 is to receive notifications and reminders. As indicated by the box entry form 62, the user 38 may indicate that he would like to receive notifications on a Web site or through e-mail. As shown, a window may show the user's current notifications for specific merchants. The window in FIG. 5 currently indicates “You have no notifications”. All of these selections and other information necessary to facilitate notifications and reminders may be may be stored in the database 30 in the system.

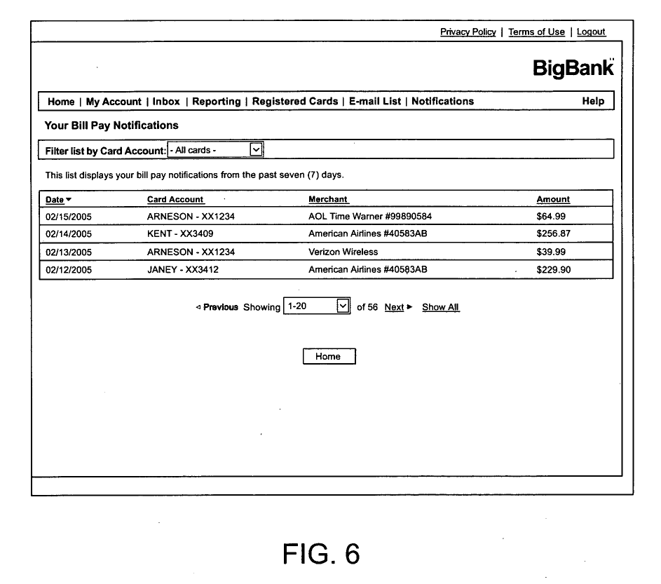

FIG. 6 shows a Web page showing various notifications for automatic bill payments for various users. The Web page displays the date that the automatic payment was made, the card account number, the merchant, and the amount of the charge. Other Web pages may show debit and credit charges made by a particular user in a single report. The charges may also be categorized (e.g., by fuel, utilities, food, etc.) so that small business owners can better manage their expenses. Such embodiments are described in detail in 60/715,455, filed on Sep. 8, 2005 and entitled “Method and System For Manipulating Purchase Information”. This application is herein incorporated by reference in its entirety for all purposes.

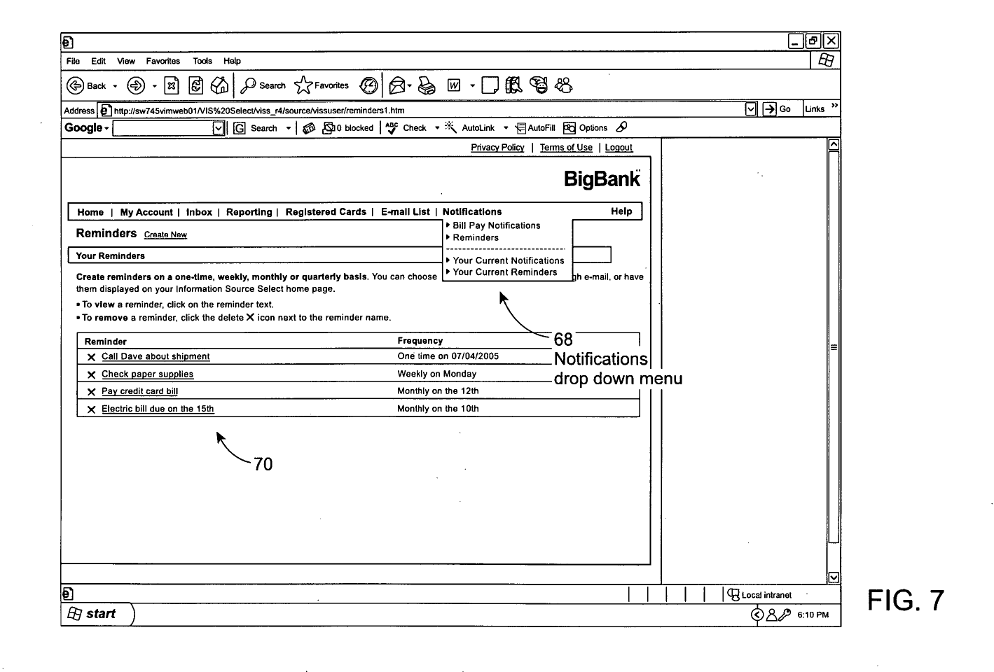

The user 38 may thereafter create, modify, and/or delete any suitable number of reminders. Using a drop down menu 68 (see FIG. 7), the user 38 may choose to look at his current notifications and reminders. The user can see a summarized list of reminders for a predetermined period of time (e.g., the last seven days). As shown, the user can view the list of reminders created and the user will see the text description of the reminders and the frequency of the reminders. For instance, as shown on the Web page in FIG. 7, the reminder “Electric bill due on the 15^{th}” was created by the user 38. As shown, the reminder is scheduled to be provided to the user 38 on the 10^{th} of each month.

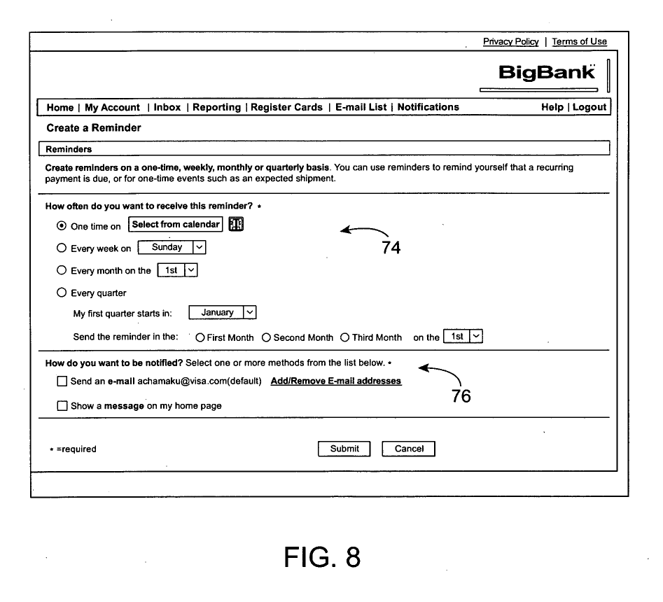

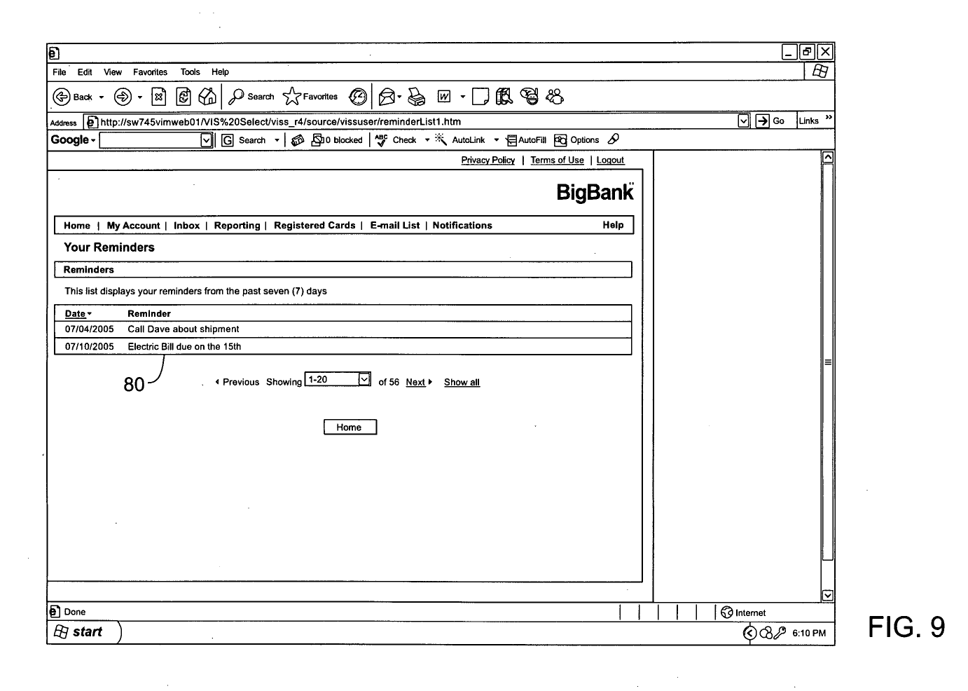

As shown on the Web page in FIG. 8, the user 38 may indicate how often reminders are to be received (see reference number 74). The reminders may occur one time, every week, month, quarter, etc. An area 76 of the Web page may allow the user 38 to select the particular mode of receiving the reminders (e.g., via e-mail or posted on a Web page). FIG. 9 shows a Web page with an actual reminder to pay an electric bill on the 15^{th} of the current month. This reminder may have been posted to the user's Web page on the 10^{th} of the current month.

After the user 38 has received a reminder that an automatic payment will be made on the 1^{st} of the next month, automatic payment can be made. The server computer 32 can automatically send a message that the user's credit card is to be charged to the acquirer 44 and/or the issuer 48. The merchant 42 may also be notified of the payment. During the settlement and clearing process, the acquirer 44 and the issuer 48 settle their accounts, and the user 38 of the portable consumer device is then invoiced by the issuer 48 for the automatic payment that was made to the merchant 42. The user 38 can then pay the invoice (in the case of a credit card). In other embodiments, there is no communication between the reminder system and any acquirer or merchant. The actual bill payment can take place without regard to any function performed by the reminder system.

The software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiment of the present invention. Based on the disclosure and teachings provided herein, a person of ordinary skill in the art will appreciate other ways and/or methods to implement the present invention.

All patent applications, patents, and publications mentioned above are herein incorporated by reference in their entirety for all purposes.

Any recitation of “a”, “an” or “the” is intended to mean “one or more” unless specifically indicated to the contrary.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method comprising:
providing for an automatic bill payment process for a user of a portable consumer device, wherein the automatic bill payment process automatically pays periodic bills of the user at predetermined times; and
providing for an automatic reminder process, wherein the automatic reminder process automatically sends reminders to the user of the portable consumer device prior to the automatic payment of the bills at the predetermined times.

2. The method of claim 1 further comprising:
providing for an automatic bill payment notification process, wherein the automatic bill payment notification process automatically notifies the user that the automatic payment of the bills at the predetermined times has occurred.

3. The method of claim 1 wherein the automatic bill payment process uses an account number associated with the user's portable consumer device.

4. The method of claim 1 wherein the portable consumer device is in the form of a credit card or a debit card.

5. The method of claim 1 wherein the predetermined times are at monthly intervals or other intervals.

6. The method of claim 1 wherein the reminders are posted on a Web page accessible to the user.

7. The method of claim 1 wherein the reminders are e-mail reminders sent to the user's e-mail account.

8. A computer readable medium comprising computer code for performing the method of claim 1.

9. A server computer comprising the computer readable medium of claim 8.

10. A system comprising:
the server computer of claim 9; and
one or more client computers in operative communication with the server computer.

11. A method comprising:
initiating an automatic bill payment process, wherein the automatic bill payment process automatically pays periodic bills of a user of a portable consumer device at predetermined times; and
initiating an automatic reminder process, wherein the automatic reminder process automatically sends reminders to the user prior to the automatic payment of the bills at the predetermined times.

12. The method of claim 11 further comprising:
selecting an automatic bill payment notification process, wherein the automatic bill payment notification process automatically notifies the user that the automatic payment of the bills at the predetermined times has occurred

13. The method of claim 11 wherein the automatic bill payment process uses an account number associated with the user's portable consumer device.

14. The method of claim 11 wherein the portable consumer device is in the form of a credit card or a debit card.

15. The method of claim 11 further comprising:
viewing the reminders on a Web page accessible to the user

16. The method of claim 11 wherein the reminders are e-mail reminders sent to the user's e-mail account.

17. A computer readable medium comprising computer code for performing the method of claim 11.

18. A server computer comprising the computer readable medium of claim 17.

19. A system comprising:
the server computer of claim 11; and
one or more client computers in operative communication with the server computer.
